(19) United States
(12) Patent Application Publication
(10) Pub. No.: US 2023/0394666 A1
(43) Pub. Date: Dec. 7, 2023

(54) INFORMATION PROCESSING APPARATUS, INFORMATION PROCESSING METHOD AND INFORMATION PROCESSING PROGRAM

(71) Applicant: Cresco Ltd., Tokyo (JP)

(72) Inventor: Yuji Ayatsuka, Tokyo (JP)

(21) Appl. No.: 18/237,467

(22) Filed: Aug. 24, 2023

Related U.S. Application Data
(63) Continuation of application No. PCT/JP2022/004572, filed on Feb. 7, 2022.

(30) Foreign Application Priority Data
Feb. 24, 2021 (JP) 2021-027404

(51) Int. Cl. G06T 7/00; G06T 5/50

(52) U.S. Cl. CPC G06T 7/0014; G06T 5/50; G06T 2207/20224; G06T 2207/20084; G06T 2207/30041

(57) ABSTRACT

A processing apparatus includes an acquisition unit that acquires a first image on the basis of first image information; a computation unit that computes a difference between the first image and a second image in accordance with classification of an object on the basis of the first image acquired by the acquisition unit and the second image obtained by hiding the first image on the basis of the first image information acquired by the acquisition unit by a mask that is smaller than a size of the first image; and a generator that, on the basis of a difference in accordance with the classification computed by the computation unit, generates a third image indicating a location where the difference occurs.

### INCORPORATION BY REFERENCE

This application is a continuation application of International Application No. PCT/JP2022/004572, filed on Feb. 7, 2022, which claims priority of Japanese (JP) Patent Application No. 2021-027404, filed on Feb. 24, 2021, the contents of which are hereby incorporated by reference in its entirety.

### TECHNICAL FIELD

This disclosure relates to an information processing apparatus, information processing method, and information processing program.

### BACKGROUND

A technique for detecting an object recorded in an image has existed conventionally. For example, the technique described in Japanese Laid-Open Patent Publication No. 2016-157219 uses a neural network to detect an object recorded in an image.

In the conventional technique for detecting an object utilizing a neural network, a specific object is presumed to be present at a location where the feature quantity obtained from the image is great. The detection technique focuses on visualization of a location where a particular object is present. However, when a particular object is identified (or classified), the point of determination as to a reason why the object is classified as such has not been visualized conventionally.

It could therefore be helpful to provide an information processing apparatus, an information processing method, and an information processing program that classify an object recorded in an image and present a location of the object.

### SUMMARY

An information processing apparatus includes: an acquisition unit that acquires first image information on the basis of a first image; a computation unit that computes a difference between the first image and a second image in accordance with classification of an object on the basis of the first image acquired by the acquisition unit and the second image obtained by hiding the first image on the basis of the first image information acquired by the acquisition unit by a mask that is smaller than a size of the first image; and a generator that, on the basis of a difference in accordance with the classification computed by the computation unit, generates a third image indicating a location where the difference occurs.

The computation unit may compute a difference, in accordance with each of a plurality of second images, between the first image and each of the second images obtained by hiding the first image by a corresponding one of a plurality of different masks.

The computation unit may be configured to: compute a difference, in accordance with each of a plurality of second images, between the first image and each of the second images obtained by hiding different locations in the first image by a plurality of corresponding first masks each having a first size; and compute a difference, in accordance with each of a plurality of second images, between the first image and each of the second images obtained by hiding different locations in the first image by a plurality of corresponding second masks each having a second size that is different from the first size, and the generator may generate a composite image of a third image related to the difference in accordance with the classification on the basis of each of a plurality of the second images in accordance with a corresponding one of the first masks and a third image related to the difference in accordance with the classification on the basis of each of a plurality of the second images in accordance with a corresponding one of the second masks.

The computation unit may compute the difference on the basis of a plurality of the first masks with a total number of which being odd and a plurality of the second masks with a total number of which being odd.

The computation unit may compute a difference between: a first value obtained by entering the first image to a neural network having a learning model generated by learning the object in advance to be output for each classification of the object; and a second value obtained by entering the second image to the neural network to be output for each classification of the object.

The computation unit may output the first and second values in accordance with a type of fundus disease as the classification of the object on the basis of the learning model that has learned images in which a plurality of fundus diseases are recorded as the object.

The generator may be configured to: if a numerical value representing the difference computed by the computation unit indicates one of positive and negative values, presume that the object recorded in the first image, which is hidden by the mask, corresponds to a positive contribution; and if a numerical value representing the difference computed by the computation unit indicates another of the positive and negative values, presume that the object recorded in the first image, which is hidden by the mask, corresponds to a negative contribution.

The generator may be configured to: if a numerical value representing a difference computed by the computation unit indicates one of positive and negative values, indicate a location where the difference occurs in a third image in a first mode; and if a numerical value representing a difference computed by the computation unit indicates another of the positive and negative values, indicate a location where the difference occurs in the third image in a second mode that is different from the first mode.

The generator may be configured to: if a numerical value representing a difference computed by the computation unit is relatively great, presume that the object recorded in the first image, which is hidden by the mask, is relatively likely to correspond to classification of the difference computed by the computation unit; and if a numerical value representing a difference computed by the computation unit is relatively small, presume that the object recorded in the first image, which is hidden by the mask, is relatively unlikely to correspond to the classification of the difference computed by the computation unit.

The generator may be configured to: if a numerical value representing a difference computed by the computation unit is relatively great, indicate a location where the difference occurs in a third image in a third mode; and if a numerical value representing a difference computed by the computation unit is relatively small, indicate a location where the difference occurs in the third image in a fourth mode that is different from the third mode.

An information processing method causes a computer to execute the steps of: acquiring first image information on the basis of a first image; computing a difference between the first image and a second image in accordance with classification of an object on the basis of the first image acquired in the acquiring step and the second image obtained by hiding the first image on the basis of the first image information acquired in the acquiring step by a mask that is smaller than a size of the first image; and generating, on the basis of a difference in accordance with the classification computed in the computing step, a third image indicating a location where the difference occurs.

An information processing program causes a computer to embody the functions of: acquiring first image information on the basis of a first image; computing a difference between the first image and a second image in accordance with classification of an object on the basis of the first image acquired by the acquiring function and the second image obtained by hiding the first image on the basis of the first image information acquired by the acquiring function by a mask that is smaller than a size of the first image; and generating, on the basis of a difference in accordance with the classification computed by the computing function, a third image indicating a location where the difference occurs.

An information processing apparatus acquires a first image (first image information), computes a difference between the first image and a second image in accordance with classification of an object on the basis of the first image and the second image obtained by hiding the first image by a mask that is smaller than the size of the first image, and generates a third image that shows a location where the difference occurs. This allows the apparatus to classify the object recorded in the image and present the location of the object.

The information processing method and the information processing program may have the same advantages as those of the information processing apparatus described above.

### BRIEF DESCRIPTION OF THE DRAWINGS

Features, advantages, and technical and industrial significance of examples will be described below with reference to the accompanying drawings, in which like numerals denote like elements.

FIG. 1 is a diagram illustrating an information processing apparatus according to an example.

FIG. 2 is a block diagram illustrating the information processing apparatus according to the example.

FIG. 3 is a diagram illustrating an example of a first image.

FIGS. 4A to 4I are diagrams each illustrating an example of a mask.

FIG. 5 is a schematic diagram illustrating a configuration of a neural network.

FIG. 6 is a diagram illustrating an example when a computation unit computes a difference.

FIGS. 7A and 7B are diagrams illustrating examples of a plurality of masks of different sizes.

FIG. 8 is a diagram illustrating an example of a third image.

FIG. 9 is a flowchart illustrating an information processing method according to an example.

FIGS. 10A to 10D are diagrams each illustrating examples of third images generated by a generator.

FIG. 11 is a diagram illustrating examples of images generated by the generator.

### DESCRIPTION OF THE REFERENCE NUMERALS

1: information processing system
10: server
20: external terminal
30: information processing apparatus
31: controller
32: acquisition unit
33: computation unit
34: generator
35: communication unit
36: storage
37: display

### DETAILED DESCRIPTION

An example will be described below.

The term “information” is used, but the term “information” may be rephrased as “data” and the term “data” may be rephrased as “information.”

An example describes a method of analyzing and visualizing a machine learning model for image diagnosis, i.e., an information processing system 1 that performs the visualization.

First, a brief overview of the information processing system 1 according to an example will be described.

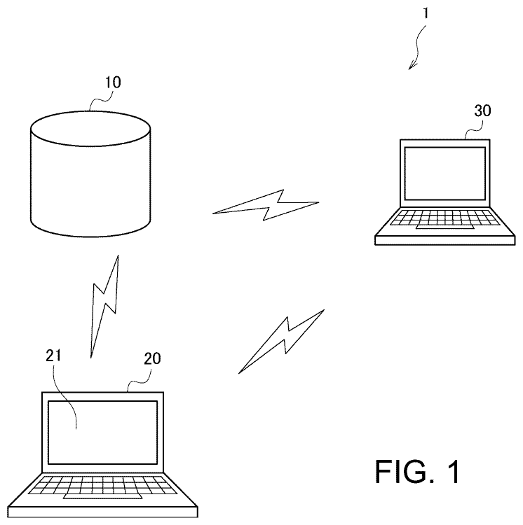

FIG. 1 is a diagram illustrating an information processing system 1 according to the example.

For the information processing system 1, a server 10, external terminal(s) 20, and information processing apparatus 30 will be described.

The server 10 stores first images (first image information) to be used by the information processing apparatus 30 and also transmits the first images (first image information) to the information processing apparatus 30. The first images may correspond to, for example, images related to a patient, captured in a hospital or dental hospital. As a specific example, the first images may be directed to various images such as an optical coherence tomography (OCT) image, an X-ray image, a computed tomography (CT) image, and a magnetic resonance imaging (MRI) image. The first images are not limited to the examples described above, but may be various images used to classify an object recorded in each image and identify the location of the object such as a weather-related image captured by meteorological satellites (weather image) and image of a living organism such as an animal and insect (biological image), for example.

The external terminals 20 may correspond to, for example, terminals located outside of the information processing apparatus 30 and server 10. The external terminals 20 are distributed in a variety of facilities such as hospitals and dental clinics, for example. Each external terminal 20 may be directed to, for example, a desktop, laptop, tablet, and smartphone. The external terminal 20 transmits the first image to the server 10. The external terminal 20 also receives and outputs the results of the classification of the object recorded in the first image in the information processing apparatus 30 and the location of the object on the first image and the identified results. For example, as a form of the output, the external terminal 20 displays on the terminal display 21 the results of the classification of the object in the information processing apparatus 30 and the results of identification of the location of it.

The information processing apparatus 30 may be directed to, for example, a computer (e.g., a server, desktop, and laptop). The information processing apparatus 30 acquires the first image from the server 10, for example. The information processing apparatus 30 may also acquire the first image from the external terminal 20, for example. The information processing apparatus 30 uses, for example, machine learning, to classify an object to be recorded in the first image and to identify the location of the object on the first image. In this example, the information processing apparatus 30 masks a portion of the first image and presumes whether the masked portion on the first image effects the classification of the object by comparing it with the non-masked first image (the original image). If the masked portion on the first image effects particular classification of the object, the information processing apparatus 30 identifies the portion of the first image that contributes to the particular classification as being present in the masked portion. As a specific example, if a masked portion in the first image contains a specific symptom, a difference occurs between the masked portion in the first image and the portion in the original image. Accordingly, the masked portion is presumed to contain an object indicating the specific symptom to identify the location of the masked portion. The information processing apparatus 30 may, for example, generate an image (e.g., a third image described below) that records the results of the classification of the object and the results of the identification of the location of the object. The information processing apparatus 30 transmits the results of the classification and the results of the identification of the location (third image) to at least one of the server 10 and the external terminal 20.

The information processing apparatus 30 is not limited to the example of classifying the symptom recorded in the image and identifying the location of the symptom. The information processing apparatus 30 may classify clouds recorded in a weather image and identify the location of the classified clouds, or classify an organism recorded in a biological image and identify the location of the object (feature) used for the classification. The information processing apparatus 30 is not limited to the examples described above, but can be used for a variety of objects in which the information processing apparatus 30 classifies the objects recorded in images and identifies the locations of the classified objects.

Next, the information processing apparatus 30 according to an example will be described in detail.

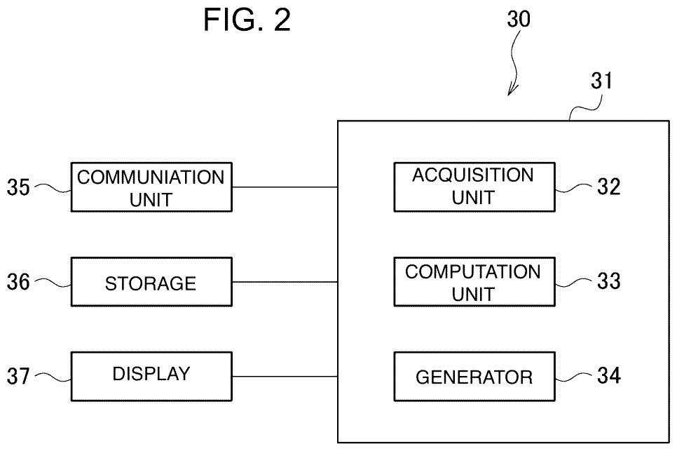

FIG. 2 is a block diagram illustrating the information processing apparatus 30 according to an example.

The information processing apparatus 30 includes a communication unit 35, storage 36, display 37, acquisition unit 32, computation unit 33, and generator 34. The acquisition unit 32, computation unit 33, and generator 34 each may be embodied as functions of a controller 31 (e.g., arithmetic processing unit) of the information processing apparatus 30.

The communication unit 35 communicates with, for example, the server 10 and external terminal 20. That is, the communication unit 35 transmits and receives information to and from, for example, the server 10 and external terminal 20, respectively. The communication unit 35 receives the first image information, for example, from outside the information processing apparatus 30 (e.g., the server 10 and external terminal 20). The communication unit 35, for example, transmits information obtained by the process described below, i.e., information on the classification results of the object recorded in the first image and the result of identifying the location of the object (third image) to the outside (e.g., server 10 and external terminal 20).

The storage 36 may store various information and programs, for example. The storage 36 stores, for example, information obtained by the process described below, i.e., information on the classification results of the object recorded in the first image and the identification results of the location of the object (third image).

The display 37, for example, displays various characters, symbols, and images. The display 37, for example, displays the information obtained by the process described below, i.e., the classification results of the object recorded in the first image and the identification results of the location of the object (third image).

The acquisition unit 32 acquires the first image information on the basis of the first image. That is, the acquisition unit 32 acquires the first image information from at least one of the server 10 and the external terminal 20 via the communication unit 35. The first image may correspond to an image about a patient captured in, for example, hospitals and dental hospitals as described above, or it may correspond to various images used to classify an object recorded in an image and identify a location of it.

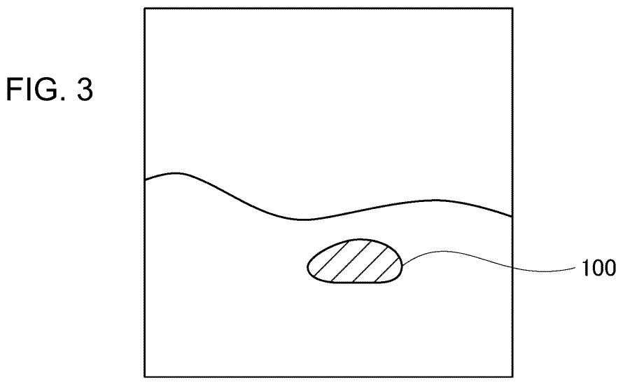

FIG. 3 is a diagram illustrating an example of the first image.

As an example is shown in FIG. 3, the first image records an object 100 that exhibits a particular symptom. As an example, the first image may correspond to an OCT image in which the presence of fundus disease is presumed, or it may be various other images such as those described above.

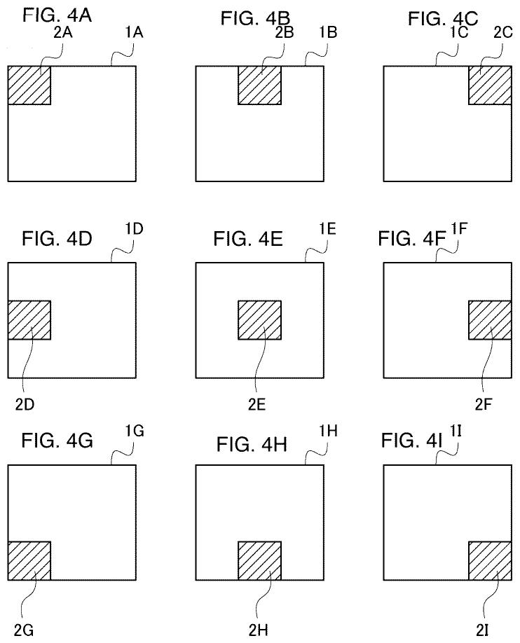

FIGS. 4A to 4I each are diagrams illustrating an example of a mask.

The computation unit 33 computes the difference between the first image (first value to be described later) and each of second images (second value to be described later) in accordance with the classification of the object on the basis of the first image acquired by the acquisition unit 32 and each second image obtained by hiding the first image on the basis of the first image information acquired by the acquisition unit 32 by a mask that is smaller than the size of the first image.

First, the computation unit 33 covers a portion of the first image with a mask that covers that first image.

The computation unit 33, for example, divides the first image vertically and horizontally into three portions (divided into 3×3), covers the portions after the division with corresponding masks, and generates second images. In this example, the computation unit 33 duplicates the first image to generate nine first images 1A to 1I. For example, the generator 34 generates a second image A by covering the top left portion of the first image 1A acquired by the division of 3×3 with a mask 2A (see FIG. 4A), a second image B by covering the top middle portion of the first image 1B acquired by the division of 3×3 with a mask 2B (see FIG. 4B), and a second image C by covering the top right portion of the first image 1C acquired by the division of 3×3 with a mask 2C (see FIG. 4C). The generator 34 also covers the first images 1D to 1I with the corresponding masks 2D to 2I as described above, and generates the second images D to I accordingly.

Alternatively, the computation unit 33 may, for example, generate the second images A to I by sequentially covering one first image with the masks 2A to 2I described above.

The computation unit 33 may compute the difference between the first image and each of a plurality of second images obtained by hiding the first image by corresponding one of a plurality of different masks. That is, the computation unit 33 computes the difference between the first image and each of the second images A to I on the basis of the first image (original image) before hiding it with the masks and the second images A to I as described above.

In this example, the computation unit 33 may enter the first image to a neural network having a learning model generated by learning objects in advance, and compute the first value output for each classification of the object. The computation unit 33 may also enter the second images to the neural network described above to compute the second value output for each classification of the object. Further, the computation unit 33 may compute the difference between the first value and each second value.

For example, the computation unit 33 acquires a learning model by learning various images (e.g., images in which object classification is recorded) to classify the object. As an example, the computation unit 33 may output the first and second values in accordance with the type of fundus disease (symptom) as the classification of the object on the basis of a learning model that has learned images in which multiple fundus diseases are recorded as the object. Alternatively, as an example, the computation unit 33 may output the first and second values in accordance with the various types of diseases (symptoms) as the classification of the object on the basis of a learning model that has learned a plurality of images in which various diseases are recorded as the object. Alternatively, as an example, the computation unit 33 may output the first and second values in accordance with the type of clouds as the classification of the object on the basis of a learning model that has learned the images in which a plurality of clouds are recorded as the object. Alternatively, as an example, the computation unit 33 may output the first and second values in accordance with the type of an organism as the classification of the object on the basis of a learning model that has learned the images in which a plurality of organisms are recorded as the object.

The computation unit 33 may obtain a learning model generated by learning one of the example images described above by the controller 31. Alternatively, the computation unit 33 may obtain a learning model generated outside the information processing apparatus 30.

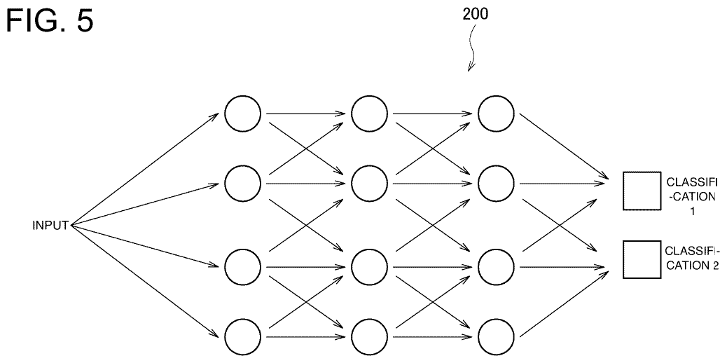

FIG. 5 is a schematic diagram for illustrating a configuration of a neural network 200.

As an example is shown in FIG. 5, when an image is entered, the neural network 200 classifies the image on the basis of the learning model and outputs the classification results (classification 1, 2). The number of classification is not limited to two as shown in FIG. 5 as an example, but may be three or more. As a specific example, when an image in which an object showing a specific symptom is recorded (e.g., an OCT image of the fundus of the eye) is entered, the neural network 200 classifies the fundus diseases of the object recorded in the OCT image on the basis of the learning model and classifies the likelihood of each of the multiple fundus diseases as a classification result. That is, the neural network 200, for example, computes a value for the likelihood as classification 1 and a value for the likelihood as classification 2 as classification results. As an example, the neural network 200 may output a relatively great value when the accuracy as a classification result is relatively high.

The computation unit 33 generates a learning model that has learned images of various symptoms or specific symptoms (as an example, fundus diseases) using machine learning, for example, in advance and classifies whether an object (diseased portion) showing a specific symptom is present in the first image on the basis of the learning model and the first image.

Next, the computation unit 33 classifies, for example, on the basis of the same learning model as above and each of the second images A to I, whether an object (diseased portion) showing a specific symptom is present in each of the second images.

That is, the computation unit 33 obtains, for example, a numerical value indicating the symptoms of the diseased portions recorded in those images as a result of classification after passing the first image and each of the second images A to I through the neural network that has learned the images of various symptoms in advance and is capable of classifying them into the symptoms. The computation unit 33 computes, for example, the difference between the first image (first value) and each of the second images A to I (second value) after passing the first image and each of the second images A to I through the neural network.

The computation unit 33 computes the difference between the first image and each of the second images A to I for each classification result as described above. For example, if the difference is relatively great, i.e., the difference between the numerical value indicating the result of particular classification 1 after the first image is passed through the neural network and the numerical value indicating the result of the particular classification 1 after each of the second images is passed through the neural network is relatively great (if the numerical value corresponding to the second image is less than the numerical value corresponding to the first image), the diseased portion is presumed to be located in the masked portion to identify the location since the effect of the symptom corresponding to the classification 1 is lower in the second image than in the original image (first image).

In contrast, for example, if the difference between the numerical value indicating the result of particular classification 1 after the first image is passed through the neural network and the numerical value indicating the result of the particular classification 1 after each of the second images is passed through the neural network is relatively great (if the numerical value corresponding to the second image is greater than the numerical value corresponding to the first image), the diseased portion is presumed to fail to be located in the masked portion to identify the location since the effect of the symptom corresponding to the classification 1 is greater in the second image than in the original image (first image).

For example, if the difference is relatively small, i.e., if the difference between the numerical value indicating the result of particular classification 1 after the first image is passed through the neural network and the numerical value indicating the result of the particular classification 1 after each of the second images is passed through the neural network is relatively small, the computation unit 33 may compute the numerical value in accordance with the difference, presume that the diseased portion is likely to be (or unlikely to be) present in the masked portion since the effect of the symptom corresponding to the classification 1 in the second image is slightly higher (or slightly lower) than in the original image (first image), and specify the location.

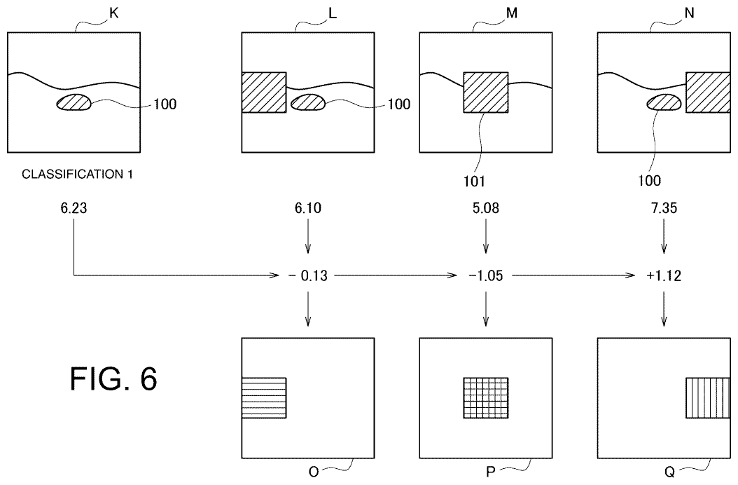

FIG. 6 illustrates an example of how the difference is computed by the computation unit 33.

As an example is shown in FIG. 6, suppose that the computation unit 33 obtained a first value of 6. 23 for classification 1 as the classification result after passing the first image K through the neural network. In the same manner, suppose that the computation unit 33 obtained the second values of 6.10, 5.08, and 7.35 for the classification 1, respectively, as the classification results after the second images L to N were passed through the neural network. Suppose that the computation unit 33 obtained each of −0.13, −1.05, and +1.12 as the difference between the first value of 6.23 and corresponding one of the second values of 6.10, 5.08, and 7.35. Since the effect of the object 100 is relatively great in the second image M and the object 100 is hidden by the mask 101, the computation unit 33 shows the second value as 5.08, which is lower than the first value of 6.23 (the difference is −1.05).

The computation unit 33 may compute the difference in accordance with each of a plurality of second images on the basis of the first image and each of the second images obtained by hiding different locations in the first image by a plurality of corresponding first masks each having the first size. Further, the computation unit 33 may compute the difference in accordance with each of a plurality of second images on the basis of the first image and each of the second images obtained by hiding different locations in the first image by a plurality of corresponding second masks each having the second size that is different from the first size. In this example, the computation unit 33 may compute the difference on the basis of a plurality of the first masks with a total number of which being odd and a plurality of the second masks with a total number of which being odd.

That is, the computation unit 33, for example, for the same image as the first image described above, utilizes masks (5×5, 7×7, 9×9 and 11×11, . . . ) (second masks) of a size different from that of the masks (3×3) (first masks) described above, and generate a plurality of second images in the same manner as in the process described above. The computation unit 33, for example, computes the difference between the first image and each of the second images in the same manner as in the process described above.

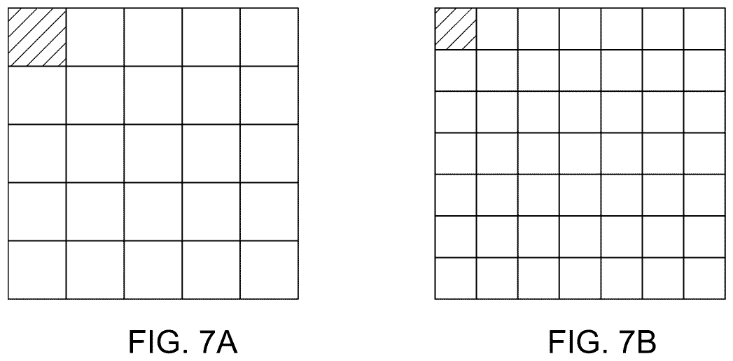

FIGS. 7A and 7B are diagrams illustrating examples of a plurality of masks of different sizes.

FIG. 7A shows a mask of 5×5 and FIG. 7B shows a mask of 7×7.

The computation unit 33 generates each second image by covering the first image using a corresponding mask of 5×5 as illustrated in FIG. 7A. In the same manner, the computation unit 33 generates each second image by covering the first image using a corresponding mask of 7×7 as illustrated in FIG. 7B.

Even when each second image is generated using the masks illustrated in FIGS. 7A and 7B, the computation unit 33 obtains each second value by performing the same process as described above and computes the difference between the first and second values.

The generator 34 generates a third image on the basis of the difference in accordance with the classification computed by the computation unit 33, which image shows the location where the difference occurs. In the example shown in FIG. 6, the generator 34 may generate each of the third images O to Q by indicating the location where the difference occurs corresponding to the masked location, and attaching a mode to the location, in accordance with the numerical value of the difference.

In this example, the generator 34 may generate a composite image of the third image related to the difference in accordance with the classification on the basis of each of a plurality of the second images in accordance with the first mask and the third image related to the difference in accordance with the classification on the basis of each of a plurality of the second images in accordance with the second mask. That is, the generator 34, for example, synthesizes, into a single image (third image), the plurality of differences computed by the computation unit 33 as described above, i.e., the differences each between the first image and corresponding one of the second images obtained on the basis of covering the first image with 3×3 masks 2A to 2I (first masks), and the differences each between the first image and each of the second images obtained on the basis of covering the first image with masks of 5×5 (and masks of 7×7, masks of 9×9, masks of 11×11, . . . ) (second masks). The generator 34 may, for example, synthesize a plurality of third images (as an example, two third images R, S) by layering and synthesizing the third images R, S into a single image in which the location of the difference recorded in the third image R and the location of the difference recorded in the third image S are both recorded.

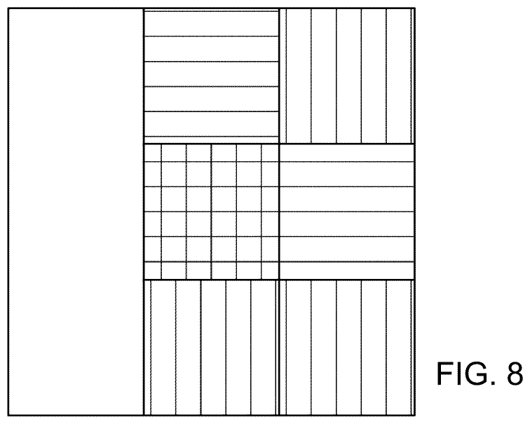

FIG. 8 is a diagram illustrating an example of the third image.

As illustrated in FIG. 8, the generator 34 is capable of synthesizing the third images into a single image to illustrate the location of the object classified as a specific symptom in the imaging range of the first image. In the first image shown in FIG. 3 and the first image K shown in FIG. 6, the object is located in the vicinity of the center of the image so that FIG. 8 also shows the location of the object classified as a specific symptom in the vicinity of the center of the third image. That is, if the first image corresponds to an OCT image in which fundus disease is recorded, the generator 34 is capable of classifying (identifying) the symptom of the fundus disease and indicating the location of the symptom.

When the numerical value representing the difference computed by the computation unit 33 indicates one of the positive and negative values, the generator 34 may indicate the location where the difference occurs in the third image in the first mode. The generator 34 may, for example, show various color forms as the first mode. As a specific example, the generator 34 may indicate the position in various colors, including red, for example, as the first mode. In this example, if the numerical value representing the difference computed by the computation unit 33 is relatively great, the generator 34 may indicate the location where the difference occurs in the third image in a third mode that is different from the first mode and the second mode described below. The generator 34 may, for example, indicate a third mode of color density. As a specific example, the generator 34 may darken the density of the color shown in the first mode, which may be a relatively dark red color, as a third mode.

If the numerical value representing the difference computed by the computation unit 33 indicates one of the positive and negative values, the generator 34 may presume that the object recorded in the first image hidden by the mask corresponds to a positive contribution. That is, if the numerical value representing the difference computed by the computation unit 33 is relatively great on one side, the generator 34 may presume that the object recorded in the first image hidden by the mask is relatively likely to correspond to the classification of the difference computed by the computation unit 33. If, for example, the difference between the first image and the second image, as shown in the third image, is relatively great on one side, that is, if the numerical value corresponding to the second image is less than the numerical value corresponding to the first image as computed by the computation unit 33, the effect of the symptom corresponding to specific classification is lower in the second image than in the original image (first image), causing the generator 34 to presume that the diseased portion is located in the masked portion and specify the location.

In contrast, if the numerical value representing the difference computed by the computation unit 33 indicates the other of the positive and negative values, the generator 34 may indicate the location where the difference occurs in the third image in the second mode that is different from the first mode. For example, the generator 34 may indicate various color forms as the second mode. As a specific example, the generator 34 may indicate the location in various colors, including blue, for example, as the second mode. In this example, if the numerical value representing the difference computed by the computation unit 33 is relatively great, the generator 34 may indicate the location where the difference occurs in the third image in the third mode that is different from the first and second modes. As described above, the generator 34 may, for example, indicate a third mode of color density. As a specific example, the generator 34 may darken the density of the color shown in the second mode, which may be a relatively dark blue color, as a third mode.

If the numerical value representing the difference computed by the computation unit 33 indicates the other of the positive and negative values, the generator 34 may presume that the object recorded in the first image hidden by the mask is a negative contribution. That is, the generator 34 presumes, for example, that the object recorded in the first image, which is hidden by the mask, has inhibition for particular classification. If the difference between the first image and the second image, as shown in the third image, is relatively great on the other side, that is, if the numerical value corresponding to the second image is higher than the numerical value corresponding to the first image as computed by the computation unit 33, the effect of the symptom corresponding to specific classification is higher in the second image than in the original image (first image), causing the generator 34 to presume that the diseased portion fails to be located in the masked portion and specify the location.

Alternatively, if the numerical value representing the difference computed by the computation unit 33 is relatively small, the generator 34 may indicate the location where the difference occurs in the third image in the fourth mode that is different from the third mode. The generator 34 may, for example, indicate a fourth mode of color density. As a specific example, the generator 34 may relatively dilute the density of the colors shown in the first and second modes as a fourth mode. That is, for example, if the location where the difference occurs is indicated in red as the first mode, the generator 34 may indicate a relatively light red color as the fourth mode. In the same manner, if the location where the difference occurs is indicated in blue as the second mode, the generator 34 may indicate a relatively light blue color as the fourth mode.

If the numerical value representing the difference computed by the computation unit 33 is relatively small, the generator 34 may presume that the object recorded in the first image hidden by the mask is relatively unlikely to correspond to the classification of the difference computed by the computation unit 33. For example, if the difference between the first image and the second image is relatively small on one side or the other, as shown in the third image, the generator 34 presumes that the effect of the symptom corresponding to classification 1 is slightly higher (or slightly lower) in the second image than in the original image (first image), depending on the numerical value indicating the difference, and that the masked portion is likely to include a diseased portion (or unlikely to include a diseased portion), and specifies the location.

The controller 31 controls the output of the presumption results by the generator 34.

The communication unit 35, for example, outputs information on the third image generated by the generator 34 to the outside on the basis of the control of the controller 31. The communication unit 35, for example, outputs the information on the third image generated by the generator 34 to at least one of the server 10 and the external terminal 20. When the external terminal 20 receives the information on the third image, it can display the third image on the terminal display 21.

The storage 36, for example, outputs the information on the third image generated by the generator 34 on the basis of the control of the controller 31.

The display 37, for example, displays the third image generated by the generator 34 on the basis of the control of the controller 31.

Next, an information processing method according to an example will be described.

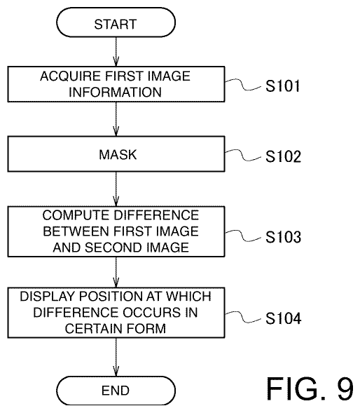

FIG. 9 is a flowchart illustrating an information processing method according to an example.

In step ST101, the acquisition unit 32 acquires the first image (first image information).

In step ST102, the computation unit 33 generates a second image by covering a portion of the first image acquired in step ST101 with a mask. In this example, the computation unit 33 may generate a plurality of second images by covering the first image with a plurality of masks of different sizes (first and second masks). The masks may cover multiple divisions of the first image, respectively, or they may be random noise. The masks (e.g., masks of 3×3, masks of 5×5, masks of 7×7, . . . ) obtained by dividing the first image, which cover the first image, may have a total number as an odd number, for example.

In step ST103, the computation unit 33 computes the difference between the first image (first value) and each of a plurality of the second images (second values). That is, the computation unit 33 computes the difference between the first value (the numerical value after classification) after the first image acquired in step ST101 is passed through the neural network and each second value (the numerical value after classification) after each second image acquired in step ST102 is passed through the neural network.

In step ST104, the generator 34 generates a third image on the basis of the difference computed in step ST103, showing the location where the difference occurs for each classification. The generator 34 may generate a composite image of the third image related to the difference in accordance with the classification on the basis of each of a plurality of the second images generated by covering the first image with the first masks and the third image related to the difference in accordance with the classification on the basis of each of a plurality of the second images generated by covering the first image with the second masks.

In this example, the generator 34 may generate each third images by indicating the location where the difference occurs corresponding to the masked location, and attaching a mode to the location, in accordance with the numerical value of the difference.

For example, if the numerical value representing the difference computed in step 103 indicates one (or the other) of the positive and negative values, the generator 34 may indicate the location where the difference occurs in the third image in the first mode (or the second mode). The first and second modes may be on the basis of, for example, different colors.

If the numerical value representing the difference computed in step ST103 is relatively great (or small), the generator 34 may indicate the location where the difference occurs in the third image in a third (or fourth) mode. The third and fourth modes may be on the basis of, for example, different color densities.

If the numerical value representing the difference computed in step ST103 indicates one of the positive and negative values (the difference is relatively great), the generator 34 may presume that the object recorded in the first image hidden by the mask corresponds to a positive contribution (likely to correspond to the classification result in step ST103).

In contrast, if the numerical value representing the difference computed in step ST103 indicates the other of the positive and negative values (the difference is relatively great), the generator 34 may presume that the object recorded in the first image to be hidden by the mask corresponds to a negative contribution (less likely to correspond to the classification result in step ST103, that is, the inhibition against the classification is high).

If the numerical value representing the difference computed in step ST103 is relatively small, the generator 34 may presume that the object recorded in the first image that is hidden by the mask is relatively unlikely to correspond to the classification result in step ST103.

Next, an example will be described.

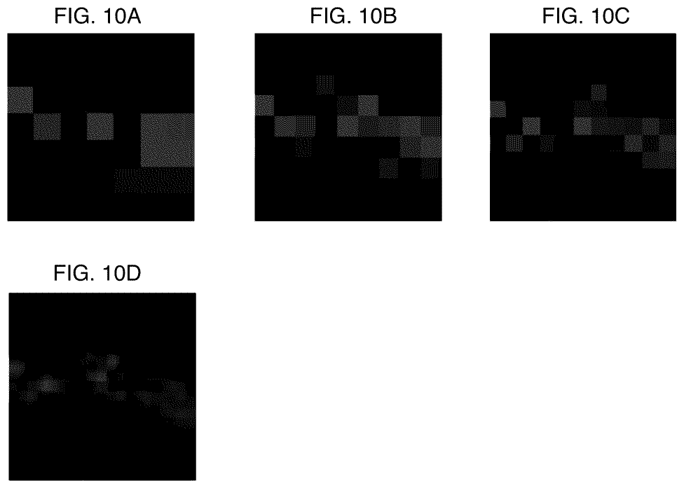

FIGS. 10A to 10D are diagrams each illustrating examples of the third images generated by the generator 34.

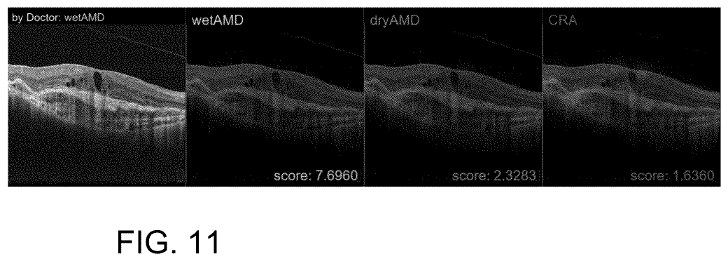

FIG. 11 is a diagram illustrating an example of each image generated by the generator 34.

The generator 34 generates each third image in accordance with the difference generated for corresponding one of masks of different sizes by the computation unit 33. For example, as shown in FIG. 10A, the generator 34 generates a third image on the basis of the differences computed by the computation unit 33 on the basis of masks of 7×7. Further, for example, as shown in FIG. 10B, the generator 34 generates a third image on the basis of the differences computed by the computation unit 33 on the basis of masks of 9×9. Moreover, for example, as shown in FIG. 10C, the generator 34 generates a third image on the basis of the differences computed by the computation unit 33 on the basis of masks of 11×11. The generator 34 generates the third image on the basis of masks of different sizes other than those illustrated in FIGS. 10A to 10C. The generator 34, for example, combines multiple third images into a single image to generate the image shown in FIG. 10D. The image illustrated in FIG. 10D corresponds to an image showing the differences computed by the computation unit 33 and the locations where the differences occur.

The generator 34 may, for example, combine the image illustrated in FIG. 10D and the first image into a single image as illustrated in FIG. 11. That is, as illustrated in FIG. 11, the generator 34 may generate an image showing, for each classification of an object (e.g., fundus disease symptom), the difference computed by the computation unit 33 and the location where the difference occurs. In this example, the generator 34 may indicate, for example, that the relatively higher the total difference (Score) of each classification, the more likely the symptom of the classification is.

Next, the advantages of this example will be described.

The information processing apparatus 30 includes an acquisition unit 32 that acquires a first image (first image information); a computation unit 33 that computes a difference between the first image and the second image in accordance with the classification of the object where the second image is obtained by hiding the first image by a mask smaller than the size of the first image; and a generator 34 that generates a third image that shows the location where the difference occurs.

When an object for classification is present in the masked portion, the information processing apparatus 30 is capable of obtaining the difference between the first image and the second image to obtain the effect of the object. On the basis of the difference between the first image and the second image, the information processing apparatus 30 is capable of classifying the object (target) recorded in the image and presenting the location of the object (target).

In the information processing apparatus 30, the computation unit 33 may compute the difference, in accordance with each of a plurality of second images, between the first image and each of the second images obtained by hiding the first image by a plurality of corresponding different masks.

The information processing apparatus 30 is capable of hiding the object (target) recorded in the first image by each of the masks. The information processing apparatus 30 is capable of obtaining the effect of an object (target) in the first image by obtaining the difference between the first image and each of the second images. This allows the information processing apparatus 30 to identify the location of the object (target).

In the information processing apparatus 30, the computation unit 33 may compute the difference, in accordance with each of a plurality of second images, between the first image and each of the second images obtained by hiding different locations in the first image by a plurality of corresponding first masks having the first size. The computation unit 33 may compute the difference, in accordance with each of a plurality of second images, between the first image and each of the second images obtained by hiding different locations in the first image by a plurality of corresponding second masks each having the second size. In this example, the generator 34 may generate a composite image of the third image related to the difference in accordance with the classification on the basis of each of a plurality of the second images in accordance with the corresponding first masks and the third image related to the difference in accordance with the classification on the basis of each of a plurality of the second images in accordance with the corresponding second masks.

The information processing apparatus 30 uses masks of a plurality of sizes (first and second masks) to hide corresponding portions of the first image, allowing it to more accurately identify the location of the object (target) even if the size of the object (target) is unknown. That is, when the size of the object (target) is relatively great, the information processing apparatus 30 is capable of hiding the object (target) in the first image by masks of relatively great size. In the same manner, if the size of the object (target) is relatively small, the information processing apparatus 30 is capable of hiding the object (target) in the first image to allow the location of the object (target) in the first image to be identified by masks of relatively small size. This allows the information processing apparatus 30 to acquire the effect of the object (target) in the first image and to presume the classification and location of the object (target) even if the size of the object (target) in the first image is unknown by hiding the first image by a plurality of masks of different sizes.

In the information processing apparatus 30, the computation unit 33 may compute the difference on the basis of a plurality of the first masks with a total number of which being odd and a plurality of the second masks with a total number of which being odd.

This allows the information processing apparatus 30 to prevent the edges of the respective masks (the first mask and the second mask) from layering in the third image even when the first image is hidden by a plurality of masks of different sizes.

In the information processing apparatus 30, the computation unit 33 may compute the difference between the first value output for each classification of the object by entering the first image to the neural network having a learning model generated by learning the object in advance, and the second value output for each classification of the object by entering the second image to the neural network.

This allows the information processing apparatus 30 to classify the object on the basis of the previously learned results and to numerically indicate the likelihood that the object is of that classification.

In the information processing apparatus 30, the computation unit 33 may output the first and second values in accordance with the type of fundus disease (symptom) as the classification of the object on the basis of the learning model that has learned the images in which a plurality of fundus diseases are recorded as the object.

This allows the information processing apparatus 30 to classify the type (symptom) of the object (fundus diseases) recorded in the first image and to identify the location of the fundus disease.

In the information processing apparatus 30, if the numerical value representing the difference computed by the computation unit 33 indicates one of the positive and negative values, the generator 34 may presume that the object recorded in the first image hidden by the mask corresponds to a positive contribution. In this example, if the numerical value representing the difference computed by the computation unit 33 indicates the other of the positive and negative values, the generator 34 may presume that the object recorded in the first image hidden by the mask corresponds to a negative contribution.

This allows the information processing apparatus 30 to estimate that the effect of the object (target) is relatively high (low) if the numerical value of the difference is relatively great. That is, if the effect of the object (target) is greater, the information processing apparatus 30 is capable of presuming that the object (object) is relatively more likely to fall into a classification (e.g., symptom) that is presumed to have a greater effect and is located at a presumed location on the image.

In the information processing apparatus 30, if the numerical value representing the difference computed by the computation unit 33 indicates one of the positive and negative values, the generator 34 may indicate the location where the difference occurs in the third image in the first mode. In this example, if the numerical value representing the difference computed by the computation unit 33 indicates the other of the positive and negative values, the generator 34 may indicate the location where the difference occurs in the third image in the second mode different from the first mode.

This allows the information processing apparatus 30 to display a predetermined mode (e.g., color difference) if the effect of the object (target) is presumed to be relatively high (low) so that the information processing apparatus 30 can present to the user of the information processing system 1 the location of the object (target) and the likelihood that it corresponds to a presumed classification (e.g., symptom) to be easily understood.

In the information processing apparatus 30, if the numerical value representing the difference computed by the computation unit 33 is relatively great, the generator 34 may presume that the object recorded in the first image hidden by the mask is relatively likely to correspond to the classification of the difference computed by the computation unit 33. In this example, if the numerical value representing the difference computed by the computation unit 33 is relatively small, the generator 34 may presume that the object recorded in the first image hidden by the mask is relatively unlikely to correspond to the classification of the difference computed by the computation unit 33.

This allows the information processing apparatus 30 to present to the user of the information processing system 1 the location of the object (target) and the likelihood that it falls under a presumed classification (e.g., symptom).

In the information processing apparatus 30, if the numerical value representing the difference computed by the computation unit 33 is relatively great, the generator 34 may indicate the location where the difference occurs in the third image in the third mode. In this example, if the numerical value representing the difference computed by the computation unit 33 is relatively small, the generator 34 may indicate the location where the difference occurs in the third image in the fourth mode that is different from the third mode.

This allows the information processing apparatus 30 to display a predetermined mode (e.g., color density) if the effect of the object (target) is presumed to be relatively high (low) so that the information processing apparatus 30 can present to the user of the information processing system 1 the location of the object (target) and the likelihood that it corresponds to a presumed classification (e.g., symptom) to be easily understood.

The information processing method causes a computer to execute the steps of: acquiring a first image (first image information); computing a difference between the first image and the second image in accordance with the classification of the object where the second image is obtained by hiding the first image by a mask smaller than the size of the first image; and generating a third image that shows the location where the difference occurs.

When an object for classification is present in the masked portion, the information processing method is capable of obtaining the difference between the first image and the second image to obtain the effect of the object. On the basis of the difference between the first image and the second image, the information processing method is capable of classifying the object (target) recorded in the image and presenting the location of the object (target).

The information processing program causes a computer to embody the functions of: acquiring a first image (first image information); computing a difference between the first image and the second image in accordance with the classification of the object where the second image is obtained by hiding the first image by a mask smaller than the size of the first image; and generating a third image that shows the location where the difference occurs.

When an object for classification is present in the masked portion, the information processing program is capable of obtaining the difference between the first image and the second image to obtain the effect of the object. The information processing program is capable of classifying an object (target) recorded in the image on the basis of the difference between the first image and the second image, and presenting the location of the object (target).

The portions of the information processing apparatus 30 described above may be embodied by functions of an arithmetic processing unit of a computer, for example. That is, the acquisition unit 32, computation unit 33, and generator 34 (controller 31) of the information processing apparatus 30 may be embodied as acquisition, computation, and generator functions (control functions), respectively, by a computer arithmetic processing unit, for example.

The information processing program may cause a computer to perform the functions described above. The information processing program may be recorded on a computer readable non-transitory recording medium such as an external memory or an optical disk.

As described above, the portions of the information processing apparatus 30 may be embodied by a computer arithmetic processing unit, for example. The arithmetic processing unit, for example, may be configured by an integrated circuit. Accordingly, each portion of the information processing apparatus 30 may be embodied as a circuit configuring an arithmetic processing unit, for example. That is, the acquisition unit 32, computation unit 33, and generator 34 (controller 31) of the information processing apparatus 30 may be embodied as an acquisition circuit, computation circuit, and generation circuit (control circuit) configuring an arithmetic processing unit of a computer, for example.

Further, the communication unit 35, the storage 36, and the display 37 of the information processing apparatus 30 may be embodied as a communication function, a storage function, and a display function including a function of an arithmetic processing unit, for example. Moreover, the communication unit 35, the storage 36, and the display 37 of the information processing apparatus 30 may be embodied as a communication circuit, a memory circuit, and a display circuit by being configured by, for example, an integrated circuit. Furthermore, the communication unit 35, the storage 36, and the display 37 of the information processing apparatus 30 may be configured as a communication device, a storage device, and a display device by being configured by a plurality of devices, for example.

What is claimed is:

1. An information processing apparatus comprising:
an acquisition unit that acquires first image information based on a first image;
a computation unit that computes a difference between the first image and a second image in accordance with classification of an object based on the first image acquired by the acquisition unit and the second image obtained by hiding the first image based on the first image information acquired by the acquisition unit by a mask that is smaller than a size of the first image; and
a generator that, based on a difference in accordance with the classification computed by the computation unit, generates a third image indicating a location where the difference occurs.

2. The information processing apparatus according to claim 1, wherein the computation unit computes a difference, in accordance with each of a plurality of second images, between the first image and each of the second images obtained by hiding the first image by a corresponding one of a plurality of different masks.

3. The information processing apparatus according to claim 1, wherein the computation unit is configured to:
compute a difference, in accordance with each of a plurality of second images, between the first image and each of the second images obtained by hiding different locations in the first image by a plurality of corresponding first masks each having a first size; and
compute a difference, in accordance with each of a plurality of second images, between the first image and each of the second images obtained by hiding different locations in the first image by a plurality of corresponding second masks each having a second size that is different from the first size, and
the generator generates a composite image of a third image related to the difference in accordance with the classification based on each of a plurality of the second images in accordance with a corresponding one of the first masks and a third image related to the difference in accordance with the classification based on each of a plurality of the second images in accordance with a corresponding one of the second masks.

4. The information processing apparatus according to claim 3, wherein the computation unit computes the difference based on a plurality of the first masks with a total number of which being odd and a plurality of the second masks with a total number of which being odd.

5. The information processing apparatus according to claim 1, wherein the computation unit computes a difference between:
a first value obtained by entering the first image to a neural network having a learning model generated by learning the object in advance to be output for each classification of the object; and
a second value obtained by entering the second image to the neural network to be output for each classification of the object.

6. The information processing apparatus according to claim 5, wherein the computation unit outputs the first and second values in accordance with a type of fundus disease as the classification of the object based on the learning model that has learned images in which a plurality of fundus diseases are recorded as the object.

7. The information processing apparatus according to claim 1, wherein the generator is configured to:
if a numerical value representing the difference computed by the computation unit indicates one of positive and negative values, presume that the object recorded in the first image, which is hidden by the mask, corresponds to a positive contribution; and
if a numerical value representing the difference computed by the computation unit indicates another of the positive and negative values, presume that the object recorded in the first image, which is hidden by the mask, corresponds to a negative contribution.

8. The information processing apparatus according to claim 7, wherein the generator is configured to:
if a numerical value representing a difference computed by the computation unit indicates one of positive and negative values, indicate a location where the difference occurs in a third image in a first mode; and
if a numerical value representing a difference computed by the computation unit indicates another of the positive and negative values, indicate a location where the difference occurs in the third image in a second mode that is different from the first mode.

9. The information processing apparatus according to claim 1, wherein the generator is configured to:
if a numerical value representing a difference computed by the computation unit is relatively great, presume that the object recorded in the first image, which is hidden by the mask, is relatively likely to correspond to classification of the difference computed by the computation unit; and
if a numerical value representing a difference computed by the computation unit is relatively small, presume that the object recorded in the first image, which is hidden by the mask, is relatively unlikely to correspond to the classification of the difference computed by the computation unit.

10. The information processing apparatus according to claim 9, wherein the generator is configured to:
if a numerical value representing a difference computed by the computation unit is relatively great, indicate a location where the difference occurs in a third image in a third mode; and
if a numerical value representing a difference computed by the computation unit is relatively small, indicate a location where the difference occurs in the third image in a fourth mode that is different from the third mode.

11. An information processing method causing a computer to execute the steps of:
acquiring first image information based on a first image;
computing a difference between the first image and a second image in accordance with classification of an object based on the first image acquired in the acquiring step and the second image obtained by hiding the first image based on the first image information acquired in the acquiring step by a mask that is smaller than a size of the first image; and
generating, based on a difference in accordance with the classification computed in the computing step, a third image indicating a location where the difference occurs.

12. A non-transitory computer readable medium storing therein an information processing program causing a computer to:
acquire first image information based on a first image;
compute a difference between the first image and a second image in accordance with classification of an object based on the first image acquired by the acquiring function and the second image obtained by hiding the first image based on the first image information acquired by the acquiring function by a mask that is smaller than a size of the first image; and
generating, based on a difference in accordance with the classification computed by the computing function, a third image indicating a location where the difference occurs.
